(19) United States
(12) Patent Application Publication
(10) Pub. No.: US 2009/0078838 A1
(43) Pub. Date: Mar. 26, 2009

(54) Annular fan-shaped retractable honeycomb furniture assembly

(75) Inventor: Jack Chang, Hsinchu County (TW)

Correspondence Address: Jack Chang, P.O. Box 44-2049, Taipei, 10668, TW

(73) Assignee: TAISHIN HONEYCOMB CORPORATION & Jack Chang

(21) Appl. No.: 11/902,535

(22) Filed: Sep. 24, 2007

(51) Int. Cl. F16M 11/00; A47B 3/00

(52) U.S. Cl. 248/188.6; 108/41

(57) ABSTRACT

An annular fan-shaped retractable honeycomb furniture assembly includes a honeycomb core and two panels. A binder is attached to a lateral side of the honeycomb core to serve as a center point when the honeycomb core is developed into an annular shape, and has the effect of fixing and shaping. A slant or an arced surface is formed on an upper side of the honeycomb core adjacent to the binder. The panels are respectively adhered to two opposite external surfaces of the honeycomb core to sandwich the honeycomb core. Each of the panels has one side portion, which projects over an edge of the honeycomb core and is formed with a slot. A fastener tape may be provided to fix the panels together after the honeycomb core is developed or retracted.

### BACKGROUND OF THE INVENTION

(1) Field of the Invention

The invention relates to a design of an environment protective furniture assembly, and more particularly to an annular fan-shaped retractable honeycomb furniture assembly having a honeycomb core so that it is light and handy when being retracted, can be conveniently carried out and has multiple purposes.

(2) Description of the Prior Art

Conventional indoor or outdoor furniture assemblies are often made of wood or metal in order to achieve the retro and fashionable feelings. The furniture assembly usually has a high price and a large weight and is seldom moved after it has been well placed. Thus, the furniture assembly cannot be retracted when it is not used so that the space cannot be saved. In addition, the furniture assembly cannot be easily carried out because it is large in size and heavy in weight.

Consequently, a foldable furniture assembly, such as a table or a chair, has been developed. However, the foldable furniture assembly is also made of wood and metal to ensure the required intensity against the loading. However, this foldable furniture assembly still has the drawbacks that it is heavy and cannot be easily carried out. More particularly, people often sit on the ground in various outdoor activities including a concert, a gathering, a speech and ball games. If the condition of the ground is not good, it is uncomfortable to either sit on the ground or stand on the ground for a long time continuously because the loading and pressure on the feet are greater. In addition, when this furniture assembly is damaged or cannot be used any more and has to be thrown away, it takes a long time to treat this furniture assembly and the environment protective requirement cannot be satisfied.

Consequently, the associated problems induced by the design defects of the conventional indoor or outdoor furniture assembly still cannot be solved and the peripheral intensity of the furniture assembly still has to be improved. Thus, the present inventor has paid attention to the research and development according to the experience and the technology in manufacturing the associated products for many years, and thus developed this retractable honeycomb furniture assembly.

### SUMMARY OF THE INVENTION

A main object of the invention is to provide an annular fan-shaped retractable honeycomb furniture assembly, which is light and handy when being retracted easily, can be conveniently carried out and has the multiple purposes. Also, the honeycomb furniture assembly can be recycled to satisfy the environment protective effectiveness.

To achieve the above-identified objet, the invention provides a honeycomb furniture assembly mainly composed of a honeycomb core and two panels. The honeycomb core mainly has a continuous mesh honeycomb structure formed by sheets, which are laminated and regularly and repeatedly staggered. A binder is attached to one lateral side of the laminated honeycomb core. A slant or an arced surface is formed on an upper side of the honeycomb core adjacent to the binder. The two panels are respectively adhered to two opposite external surfaces of the honeycomb core to sandwich the honeycomb core. Each of the panels has one side portion, which projects over an edge of the honeycomb core and is formed with a slot to serve as a handle to facilitate the movement and carry. A fastener tape is provided to fix the panels together after the honeycomb core is developed or retracted.

In practice, different honeycomb cores with different sizes and types may be manufactured so that the developed honeycomb cores may form furniture assemblies, which include a big table, a tall stool, a short stool, a cushion, a small table and a chair with a backrest, so that the furniture assemblies can be used momentarily in various outdoor activities, including an outing, a camp, a picnic, a concert, a gathering, a speech and ball games. Thus, the utility furniture assembly is light and handy and can be conveniently retracted and carried.

The fastener tape may also be replaced with a ring loop, a locking tool or an elastic rope loop with the same function.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is an exploded view showing a decomposed honeycomb furniture assembly according to a preferred embodiment of the invention.

FIG. 2 is an assembled view showing the assembled honeycomb furniture assembly according to the preferred embodiment of the invention.

FIG. 3 is a schematic illustration showing the developed honeycomb furniture assembly according to the preferred embodiment of the invention.

FIG. 4 is a top view showing the developed honeycomb furniture assembly according to the preferred embodiment of the invention.

FIG. 5 shows an exterior of the honeycomb furniture assembly (table) according to the preferred embodiment of the invention.

FIG. 6 is a schematically cross-sectional view showing the assembly of FIG. 5.

FIG. 7 shows exteriors of the honeycomb furniture assemblies (tall and short stools) according to the preferred embodiment of the invention.

FIG. 8 shows an exterior of the honeycomb furniture assembly (cushion) according to the preferred embodiment of the invention.

FIG. 9 shows schematically cross-sectional views of the honeycomb furniture assemblies (tall and short stools) according to the preferred embodiment of the invention.

FIG. 10 shows exteriors of several honeycomb furniture assemblies according to the preferred embodiment of the invention.

FIG. 11 is an exterior plane view showing a honeycomb furniture assembly according to another preferred embodiment of the invention.

FIG. 12 is an exterior plane view showing a honeycomb furniture assembly according to still another preferred embodiment of the invention.

FIG. 13 is an exterior plane view showing a honeycomb furniture assembly according to yet still another preferred embodiment of the invention.

### DETAILED DESCRIPTION OF THE PREFERRED EMBODIMENTS

The invention will become apparent from the following detailed description of the preferred but non-limiting embodiments. The following description is made with reference to the accompanying drawings.

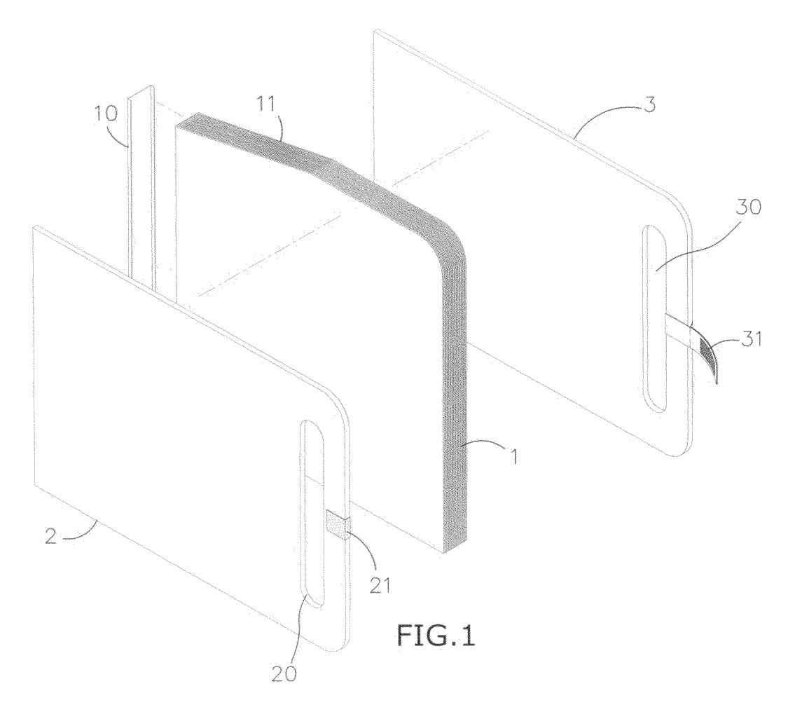

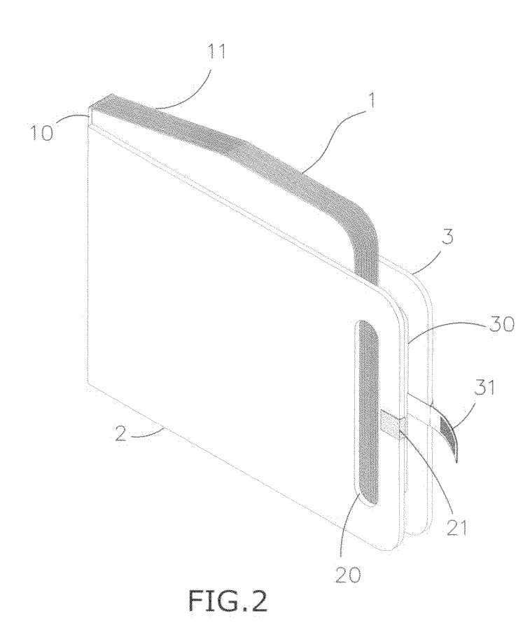

As shown in FIGS. 1 and 2, an annular fan-shaped retractable honeycomb furniture assembly of the invention includes a honeycomb core (1) and two panels (2, 3). The honeycomb core (1) is made of sheets so as to satisfy the environment protective and reproduction effectiveness. The honeycomb core (1) has a continuous mesh honeycomb structure formed by the sheets, which are laminated and regularly and repeatedly staggered. The honeycomb core (1) can be freely developed and retracted. When the honeycomb core (1) is developed to form a plurality of upright honeycomb holes, it possesses the property of withstanding the high pressure and thus can withstand the very high loading. Also, a binder (10) is attached to one lateral side of the honeycomb core (1), and a slant (11) or an arced surface is formed on an upper side of the honeycomb core (1) adjacent to the binder (10). The binder (10) may be a sheet, a cloth or an adhesive film.

The two panels (2, 3) are respectively adhered to two opposite external surfaces of the honeycomb core (1) to sandwich the honeycomb core (1). Each of the panels (2, 3) has one side portion, which projects over an edge of the honeycomb core (1) and is formed with a slot (20)/(30) to serve as a handle to facilitate the movement and carry. A fastener element (21, 31), such as a fastener tape, is provided to fix the panels (2, 3) together after the honeycomb core (1) is developed or retracted.

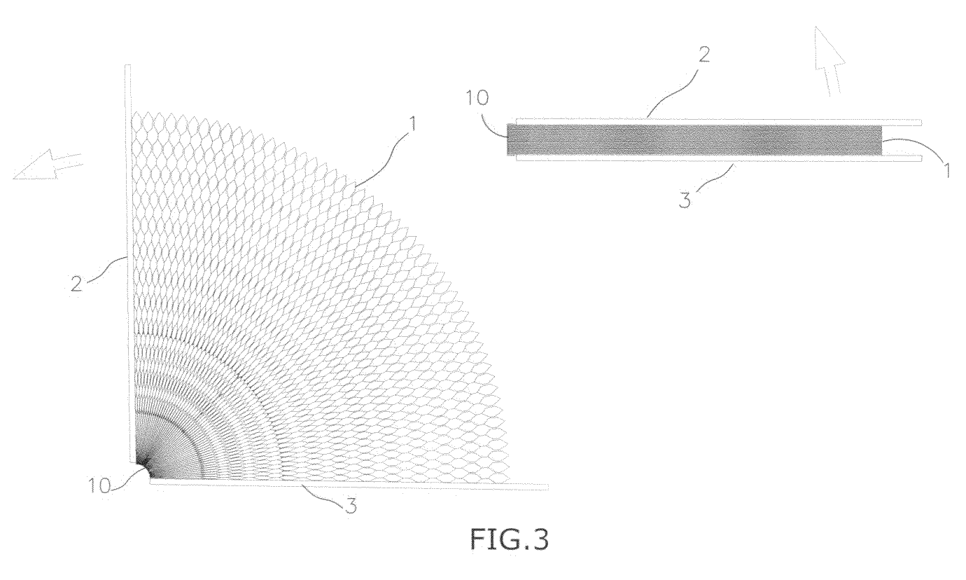

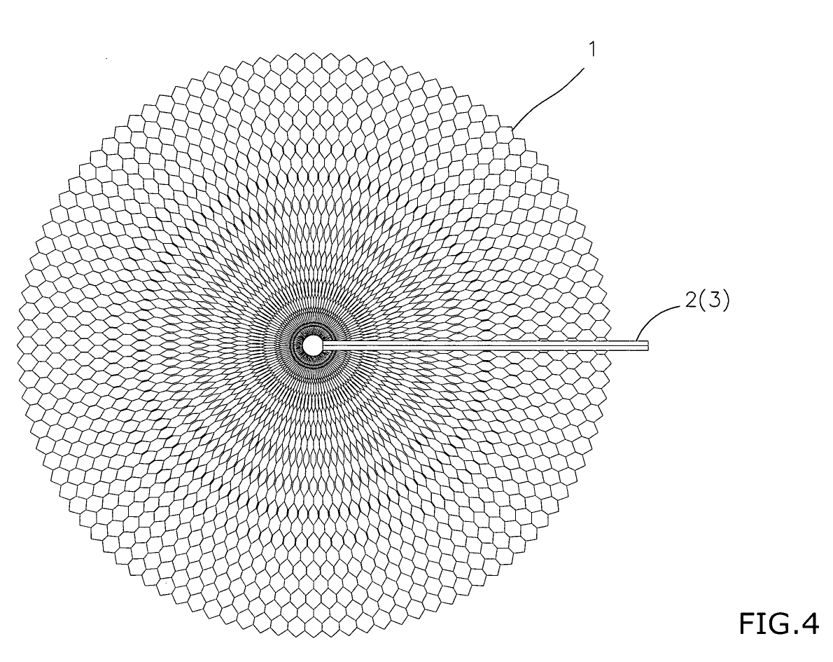

As shown in FIGS. 3 and 4, when the honeycomb core (1) is being developed, the two panels (2, 3) are rotated about the binder (10) in opposite directions (like the operation of opening a fan) and then closed to each other. In addition, the fastener tape (21, 31) is provided to fix the honeycomb core (1) to an annular cylindrical pattern.

The fastener tape (21, 31) may be replaced with a ring loop, a locking tool or an elastic rope loop having the same function as the fastener tape (21, 31).

According to the above-mentioned honeycomb furniture assembly in practice, different honeycomb cores (1) with different sizes and types may be manufactured so that the developed honeycomb cores (1) may form furniture assemblies, which include a big table, a tall stool, a short stool, a cushion, a small table and a chair with a backrest, so that the furniture assemblies can be used momentarily in various outdoor activities, including an outing, a camp, a picnic, a concert, a gathering, a speech and ball games. Thus, the utility furniture assembly is light and handy and can be conveniently retracted and carried.

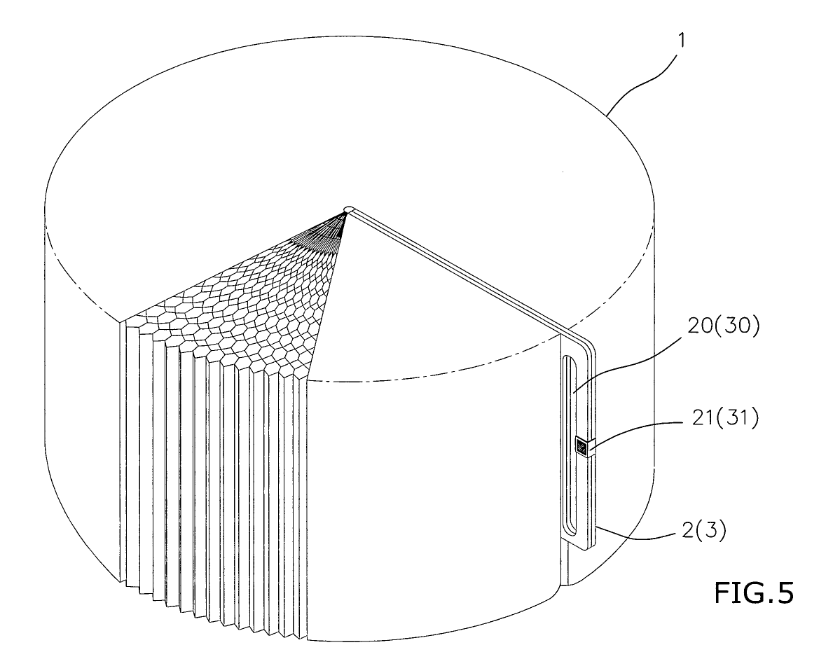

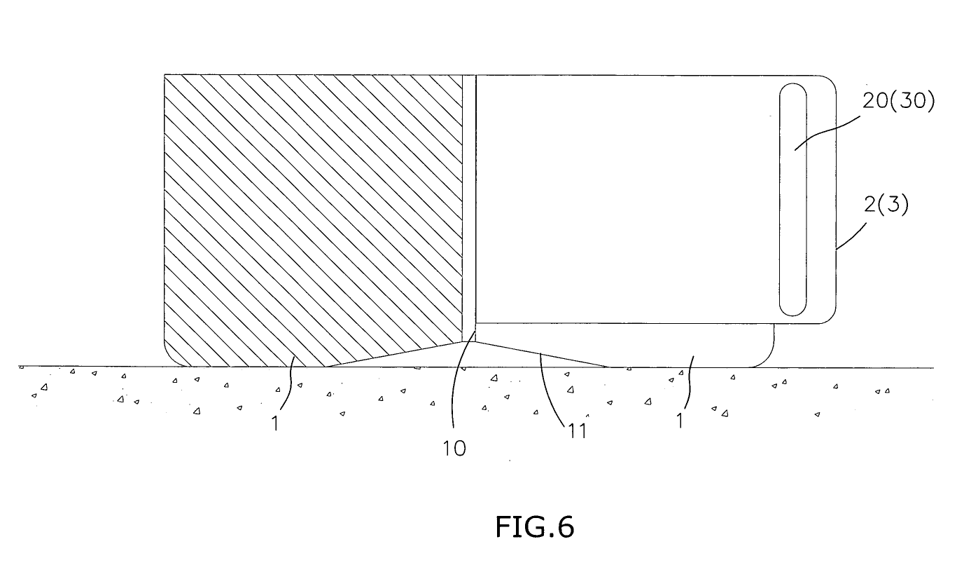

As shown in FIGS. 5 and 6, the furniture assembly is developed to form the big table. After the honeycomb core (1) is developed into the cylindrical shape and fixed by the fastener tape (21, 31), the top surface of the table is usually a plane. The concave portion formed by the developed slant (11) after being developed may face down so that the top surface of the table naturally becomes a smooth surface, and a scarf may be placed on the top surface of the table so that objects can be conveniently placed thereon.

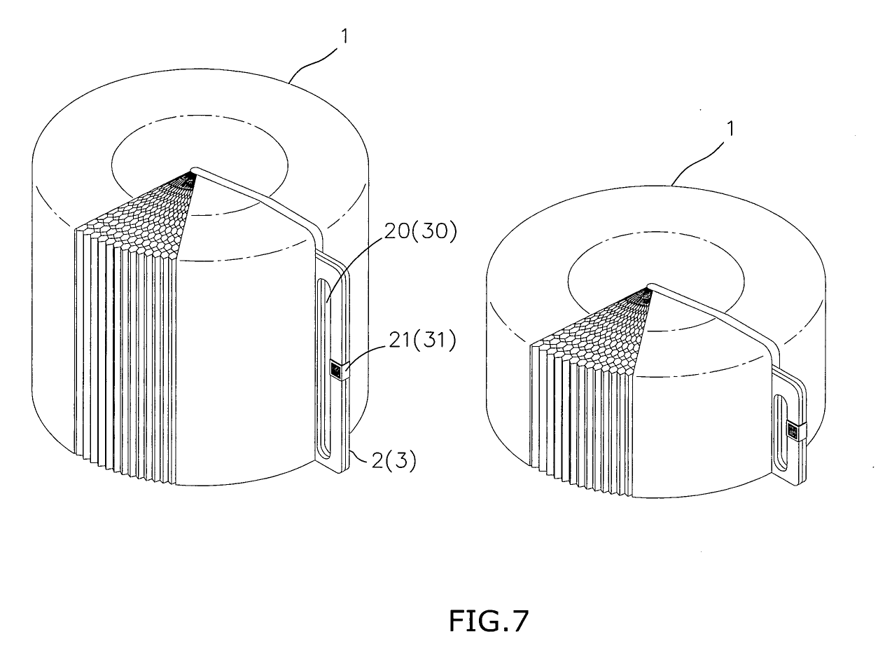

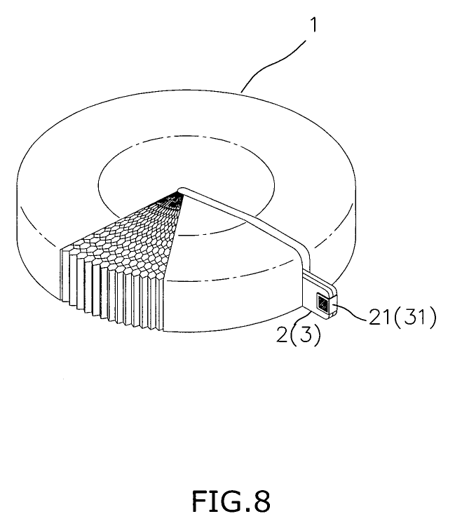

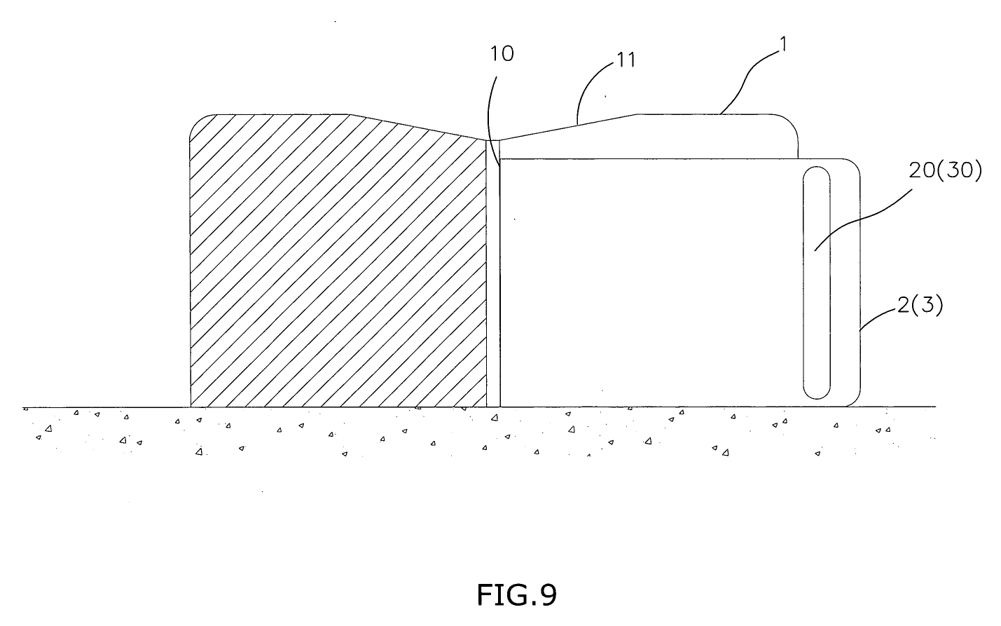

As shown in FIGS. 7 to 9, the furniture assembly is developed into tall and short stools and a cushion. In practice, the honeycomb core (1) is developed into a cylindrical shape so that the surface formed by the developed slant (11) has a concave middle portion to satisfy the human engineering posture. Then, the fastener tape (21, 31) disposed on the panels (2, 3) fixes the panels (2, 3) together. Consequently, the formed annular tall and short stools and the cushion are beautiful, symmetrical and have the sufficient intensity against the loading. Meanwhile, the honeycomb core (1) can be easily retracted, cannot occupy too much space, and can be carried conveniently.

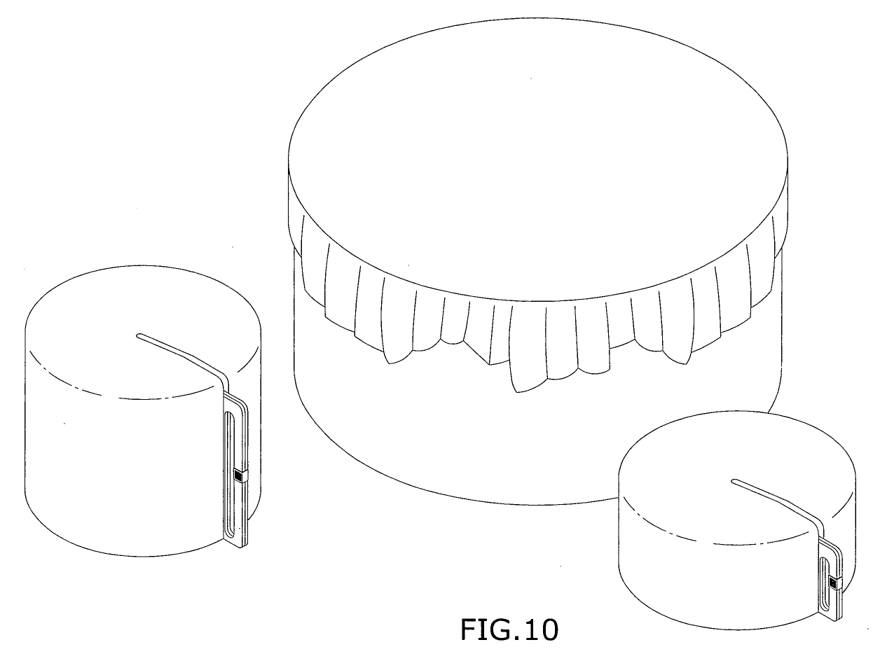

As shown in FIG. 10, different annular honeycomb furniture assemblies including different honeycomb cores (1) with different sizes are developed to form a table, a tall stool and a short stool. All the furniture assemblies have the simple, generous and smooth feelings. More particularly, the structural intensity of the assembly can support the great loading so that the assembly has the high utility. In addition, the honeycomb furniture assemblies may be easily and simply retracted into flat structures with the smaller sizes. Thus, the assemblies cannot occupy too much space, can be conveniently retracted, or can be easily carried because it is light and handy. Of course, the overall assembly may be made of the sheet material and can be recycled after it is broken so that the environment protective effectiveness can be satisfied.

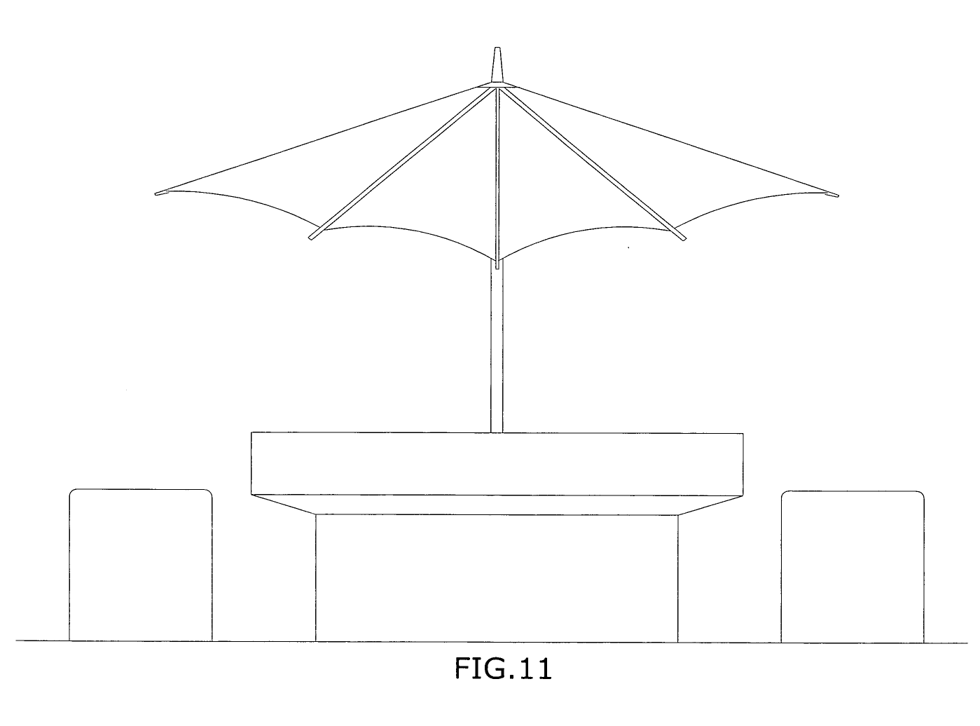

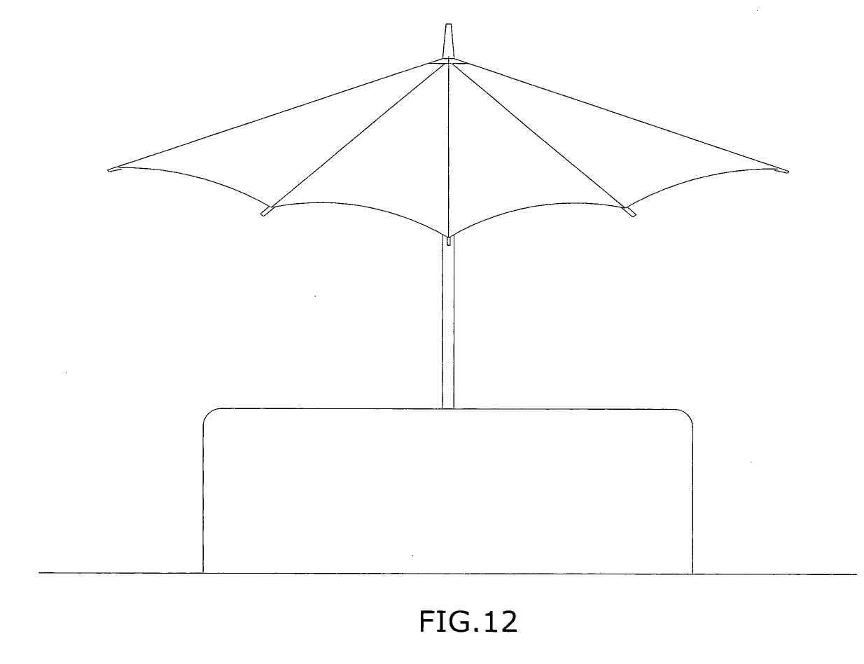

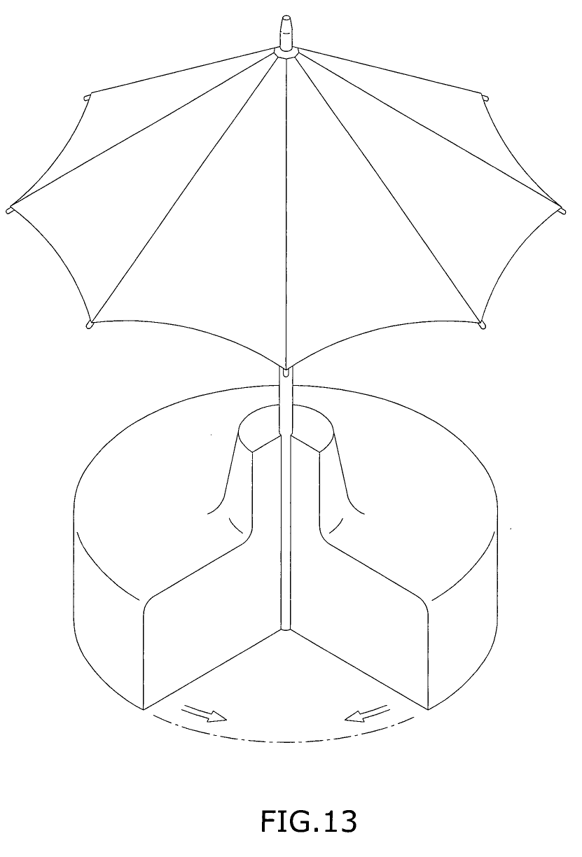

As shown in FIGS. 11 to 13, after the honeycomb furniture assembly having the honeycomb core (1) is developed to form a table, a hole can be naturally formed by the binder (10) so that a sun umbrella may be inserted into the hole. Meanwhile, the upper side of the honeycomb core (1) has the arced surface so that the honeycomb furniture assembly, which is a table or chair capable of supporting the sun umbrella, can be formed.

In summary, the annular fan-shaped retractable honeycomb furniture assembly of the invention can be easily used and has the effects better than those of the prior art.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. An annular fan-shaped retractable honeycomb furniture assembly, comprising:
a honeycomb core having a continuous mesh honeycomb structure formed by sheets, which are laminated and regularly and repeatedly staggered, wherein the honeycomb core can be freely developed and retracted, and a binder is attached to one lateral side of the laminated honeycomb core; and
two panels respectively adhered to two opposite external surfaces of the honeycomb core to sandwich the honeycomb core, wherein each of the panels has one side portion, which projects over an edge of the honeycomb core and is formed with a slot, and a fastener element is provided to fix the panels together after the honeycomb core is developed or retracted.

2. The furniture assembly according to claim 1, wherein a slant is formed on an upper side of the honeycomb core adjacent to the binder.

3. The furniture assembly according to claim 1, wherein the fastener element is a fastener tape, a ring loop, a locking tool or an elastic rope loop.

4. The furniture assembly according to claim 1, wherein an arced surface is formed on an upper side of the honeycomb core adjacent to the binder.

5. The furniture assembly according to claim 1, wherein the binder is a sheet, a cloth or an adhesive film.
